(19) United States
(12) Patent Application Publication
(10) Pub. No.: US 2023/0219297 A1
(43) Pub. Date: Jul. 13, 2023

(54) HEAT-TRANSFER DEVICES AND METHODS OF FORMING THE HEAT-TRANSFER DEVICES

(71) Applicants: Battelle Energy Alliance, LLC, Idaho Falls, ID (US); Addvanced Cooling Technologies, Inc., Lancaster, PA (US)

(72) Inventors: Patrick J. Moo, DeLand, FL (US); Michael R. Shaltry, Idaho Falls, ID (US); Donna Post Guillen, Idaho Falls, ID (US); Jeffrey Diebold, Chesterbrook, PA (US); Calin Tarau, Downingtown, PA (US); Kuan-Lin Lee, West Chester, PA (US)

(21) Appl. No.: 18/153,886

(22) Filed: Jan. 12, 2023

Related U.S. Application Data
(60) Provisional application No. 63/266,686, filed on Jan. 12, 2022.

(51) Int. Cl. B29C 64/268; F28F 21/06; F28F 21/08; B29C 64/165; F28D 15/04; B33Y 10/00; B33Y 70/10; B33Y 80/00

(52) U.S. Cl. CPC B29C 64/268; F28F 21/067; F28F 21/08; B29C 64/165; F28D 15/046; B33Y 10/00; B33Y 70/10; B33Y 80/00

(57) ABSTRACT

A heat-transfer device and methods for forming the heat-transfer device are disclosed. The method includes forming a first green structure using digital light processing, the first green structure including a different porosity in at least two sections. The method also includes exposing the first green structure to heat to remove resin used during the digital light processing from the first green structure. The method further includes sintering the first green structure to form at least a portion of the heat-transfer device.

### CROSS-REFERENCE TO RELATED APPLICATION

The present disclosure claims the benefit of priority of co-pending U.S. Provisional Application No. 63,266,686, filed on Jan. 12, 2022, and entitled “HEAT-TRANSFER DEVICES AND METHODS OF FORMING THE HEAT-TRANSFER DEVICES,” the contents of which are incorporated in full by this reference herein.

### STATEMENT REGARDING FEDERALLY SPONSORED RESEARCH OR DEVELOPMENT

This invention was made with government support under Contract Number DE-AC07-05-ID14517 awarded by the United States Department of Energy. The government has certain rights in the invention.

### TECHNICAL FIELD

This disclosure relates to heat-transfer devices, and related methods of forming the heat-transfer devices. More particularly, this disclosure relates to heat-transfer devices that include complex geometry, and methods of manufacturing such heat-transfer devices. The devices described herein may facilitate improved heat transfer rates compared to heat transfer rates of conventional heat-transfer devices.

### BACKGROUND

Heat transfer plays a significant role in the operation of modern devices and systems. Many devices and systems are designed to generate heat that can be utilized for purposes such as space heating and generating electricity. Additional devices and systems, such as those in automobile engines and electronic systems, generate heat as a byproduct that may need to be removed for operational performance. One common type heat-transfer device is a heat pipe.

Heat pipes are heat-transfer devices that combine the principles of both thermal conductivity and phase transition to effectively transfer heat between two solid interfaces. At a hot interface of a heat pipe, a working fluid in a liquid phase in contact with a thermally conductive solid surface is vaporized by absorbing heat transferred through the thermally conductive solid surface from an external environment. The vaporized working fluid travels along the heat pipe to a cold interface and condenses back into a liquid, releasing the latent heat from the vapor. The liquid working fluid returns to the hot interface through either capillary action, centrifugal force, or gravity and the cycle is repeated. Due to the latent heat transfer that occurs during the phase changes of the working fluid, heat pipes are effective thermal conductors.

Heat pipes generally include a sealed pipe or tube made of material compatible with the working fluid. For example a heat pipe that utilizes water as a working fluid may be made of or include a copper material. Additionally, a heat pipe that utilizes ammonia as a working fluid may be made of or include an aluminum material. Heat pipes may also include an internal material referred to as a wick that can be used to absorb the condensed vapor of the working fluid (e.g., the working fluid in the liquid phase), and function as a conduit through which the liquid working fluid returns to the hot interface.

### SUMMARY

In one illustrative embodiment, the present disclosure provides a method for additive manufacturing a heat-transfer device. The method includes forming a first green structure using digital light processing, the first green structure including a different porosity in at least two sections. The method also includes exposing the first green structure to heat to remove resin used during the digital light processing from the first green structure. The method further includes sintering the first green structure to form at least a portion of the heat-transfer device.

In another illustrative embodiment, the present disclosure provides a method of additively manufacturing a heat-transfer device. The method includes forming a slurry of a photocurable resin and a powder material. The method also includes depositing one or more layers of the slurry on a surface of a substrate. The method further includes using digital light processing to form one or more layers of a first green structure with a first particle distribution. The method yet further includes forming additional layers on the one or more layers of the first green structure using the digital light processing to form the first green structure, the additional layers with a second particle distribution. The method still further includes exposing the first green structure to heat to remove the resin from the first green structure. The method further includes sintering the first green structure to form the heat-transfer device, the heat-transfer device including at least two sections with different porosities.

In a further illustrative embodiment, the present disclosure provides a heat-transfer device. The heat-transfer device includes a wick including at least two sections with different porosities. The wick includes an exterior wall, an interior wall, and at least one channel. The interior wall defines a central cavity. The at least one channel is formed between the exterior wall and the interior wall.

### BRIEF DESCRIPTION OF THE DRAWINGS

While this disclosure concludes with claims particularly pointing out and distinctly claiming specific embodiments, various features and advantages of embodiments within the scope of this disclosure may be more readily ascertained from the following description when read in conjunction with the accompanying drawings. In the drawings:

FIG. 1 is a cross-sectional side view of a heat-transfer device in use and operation, in accordance with embodiments of the disclosure;

FIG. 2 is a simplified partial perspective view of a heat-transfer device, in accordance with embodiments of the disclosure;

FIG. 3A is a partial cutaway perspective view of an embodiment of a heat-transfer device, in accordance with embodiments of the disclosure;

FIG. 3B is a wireframe perspective view illustrating internal geometry of the heat-transfer device of FIG. 3A;

FIG. 4 is a perspective view of another heat-transfer device, in accordance with embodiments of the disclosure;

FIG. 5 is a perspective view of an additional heat-transfer device, in accordance with embodiments of the disclosure;

FIG. 6 is a simplified schematic illustrating stages representative of an additive manufacturing process for forming the heat-transfer devices described herein, in accordance with embodiments of the disclosure;

FIGS. 7A-7D are optical microscopy images showing the microstructure of heat-transfer devices formed according to embodiments of the disclosure under magnification after sintering materials with variations in particle size distributions at a constant temperature;

FIGS. 8A-8C are optical microscopy microscope images showing the microstructure of heat-transfer devices formed according to embodiments of the disclosure under magnification after sintering materials with a consistent particle size distribution at varying sintering temperatures; and

FIG. 9 illustrates x-ray diffraction spectra of heat-transfer devices formed according to embodiments disclosed herein.

### DETAILED DESCRIPTION

The illustrations presented in this disclosure are not necessarily meant to be actual views of any particular heat-transfer device, but are merely idealized representations employed to describe illustrative embodiments of the disclosure.

Heat-transfer devices (e.g., heat pipes) have a wide variety of applications in industry. As non-limiting examples, heat-transfer devices may be utilized in applications such as spacecraft, computer systems, solar thermal systems, permafrost cooling, cooking, heating, heating, ventilation and air-condition (HVAC) systems, nuclear power conversion, rotary combustion engines, and heat exchangers.

The rate of heat transfer may be directly proportional to the surface area through which heat is transferred. Accordingly, heat-transfer devices may be designed with increasingly complex geometries that have larger surface areas for heat transfer. Such complex geometries may, however, be difficult to manufacture using conventional manufacturing techniques (e.g., material removal processes, casting, molding, etc.).

Additive manufacturing technology is rapidly advancing and may be used to form heat-transfer devices with increasingly complex geometries. However, additive manufacturing processes may introduce difficulties not presented by conventional manufacturing techniques. For example, additive manufacturing processes may involve heat-treatment (e.g., sintering) of the additively manufactured devices to form a sintered structure, which may result in unwanted changes to the microstructure of the additively manufactured devices.

Disclosed embodiments relate generally to heat-transfer devices. More particularly, embodiments described herein include heat-transfer devices exhibiting one or more properties (e.g., dimensions, geometry, void fraction, pore size, median particle size (e.g., grain size), density, surface roughness, mechanical strength) and methods of forming the heat-transfer devices. The one or more properties of the heat-transfer devices may be tailored for a specific application. In some embodiments, additive manufacturing techniques are utilized to form one or more portions of the device having a complex geometry and/or having one or more desired properties. One or more portions of the heat-transfer devices may be formed to exhibit desired properties and be tailored to a specific application to facilitate more efficient and effective heat transfer compared to conventional devices. For example, the materials, material thicknesses, geometries of portions of the devices, and/or material properties (e.g., void fraction, pore size, median particle size, surface roughness, density, mechanical strength) of the devices disclosed herein vary (e.g., in one or more directions) at certain portions of the devices.

The devices may be formed by one or more additive manufacturing techniques including, for example, Digital Light Processing (DLP), binder jet additive manufacturing, stereolithography, powder bed fusion (e.g., direct metal laser sintering, selective laser sintering, selective heat sintering, electron beam melting, direct metal laser melting), direct energy deposition, material extrusion, or sheet lamination (e.g., laminated object manufacturing, ultrasonic additive manufacturing). In various embodiments, the heat transfer devices are formed using DLP. In some of these various embodiments, the heat transfer devices are formed using DLP with at least one other additive manufacturing technique.

The following description may include examples to enable one of ordinary skill in the art to practice the disclosed embodiments. The use of the term “for example,” means that the related description is explanatory, and though the scope of the disclosure is intended to encompass the examples and legal equivalents, the use of such terms is not intended to limit the scope of an embodiment or this disclosure to the specified components, steps, features, functions, or the like.

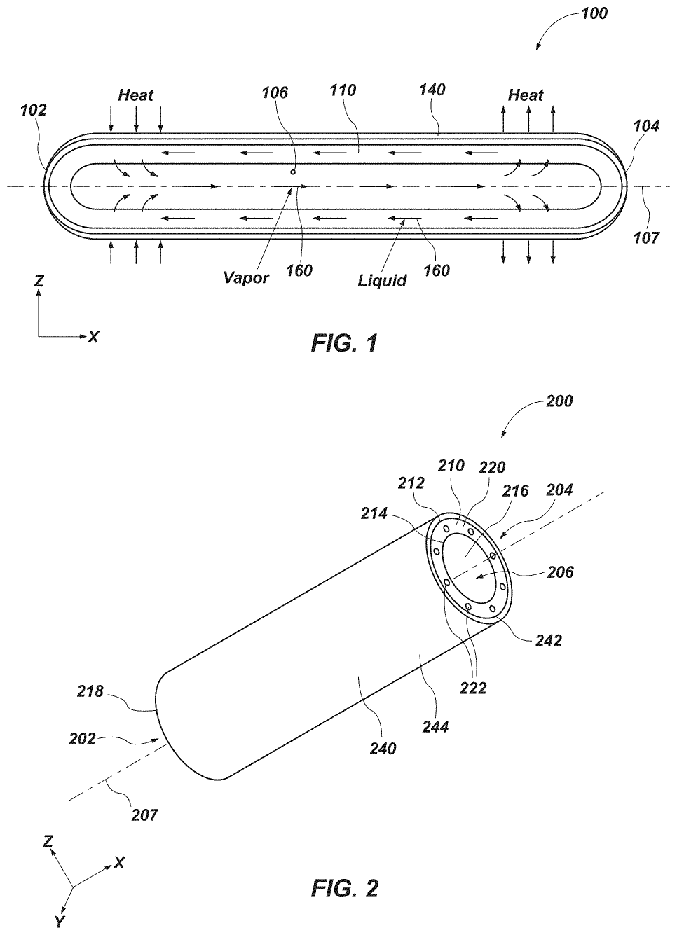

FIG. 1 is a cross-sectional side view of a heat-transfer device 100 in use and operation, in accordance with embodiments of the disclosure. In various embodiments, the heat-transfer device 100 includes a tubular structure 110 (which may also be referred to herein as a “wick”) and an exterior sheath 140 surrounding the tubular structure 110. As illustrated in FIG. 1, the heat-transfer device 100 includes a first end 102 (e.g., a hot end), and a second end 104 (e.g., a cold end) opposite the first end 102. The exterior sheath 140 extends from the first end 102 to the second end 104. In some embodiments, the tubular structure 110 extends from the first end 102 to the second end 104 within the exterior sheath 140. In some embodiments, the tubular structure 110 defines a chamber 106 including a working fluid 160. The exterior sheath 140 forms a fluid-tight (e.g., a hermetic) seal around the tubular structure 110, including the working fluid 160 configured to retain the working fluid 160 within the heat-transfer device 100 during operation thereof. In some embodiments, the exterior sheath 140, the tubular structure 110, and the chamber 106 are substantially concentrically disposed around a central axis 107 (also referred to as a longitudinal axis) extending along a length of the heat-transfer device 100 from the first end 102 to the second end 104.

In use and operation, the first end 102 (e.g., the hot end) of the heat-transfer device 100 may be a hot interface configured to transfer heat from a surrounding environment to the working fluid 160; and the second end 104 (e.g., the cold end) of the heat-transfer device 100 may be a cold interface configured to remove heat from the heat-transfer device 100 to the surrounding environment. At the first end 102 (e.g., the hot end) of the heat-transfer device 100, heat is transferred through the heat-transfer device 100 to the working fluid 160. The transfer of heat from the surrounding environment to the working fluid 160 at the first end 102 facilitates evaporation of the working fluid 160 from a liquid phase to a gaseous phase (e.g., a vapor phase). The working fluid 160 in the vapor phase may travel away from the exterior walls of the heat-transfer device 100 and toward a central portion of the chamber 106 through the tubular structure 110 (e.g., through pores of the tubular structure 110, through channels formed within the tubular structure 110). In various embodiments, the working fluid 160 in the vapor phase travels along the length of the heat-transfer device 100 along the central axis 107 to the second end 104 (e.g., the cold end) of the heat-transfer device 100. The working fluid 160 in the vapor phase condenses back into the liquid phase, releasing latent heat at the second end 104.

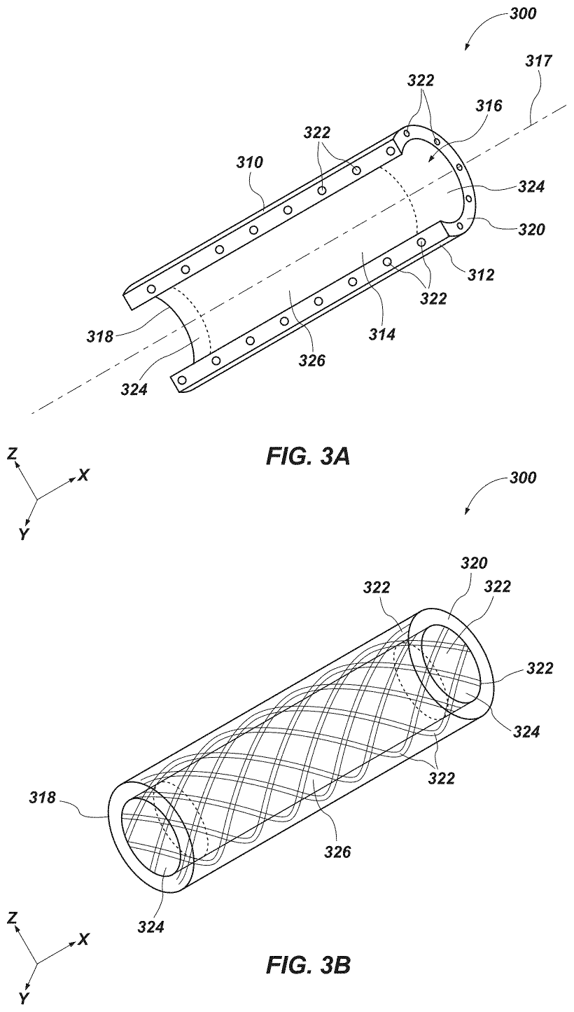

In various embodiments, the tubular structure 110 includes a porous structure configured to absorb and draw (e.g., wick, via capillary forces) the working fluid 160 in the liquid phase to the first end 102 of the heat-transfer device 100 via capillary forces caused by the porous structure. In various embodiments, the tubular structure 110 includes varying levels of porosity to define wicking properties of the tubular structure 110 and facilitate the wicking of the working fluid 160 from the second end 104 to the first end 102, as will be described in further detail below with reference to FIGS. 3A-3B.

One or more properties of the heat-transfer device 100 may be tailored (e.g., tuned, modified, adjusted) based on a specific application of the heat-transfer device 100. For example, the heat-transfer device 100 may be formed to exhibit a desired shape and/or dimensions. In some embodiments, the heat-transfer device 100 exhibits a generally tubular shape (e.g., hollow cylinder, hollow ellipse, hollow square, hollow rectangle, hollow triangle, or combinations thereof). In some embodiments, the central axis 107 defines a longitudinal direction of the heat-transfer device 100. In various embodiments, the central axis 107 extends along the geometric center of cross-sections of the chamber 106. In some embodiments, the heat transfer device 100 includes a larger dimension in the axial direction (e.g., along the central axis 107) than in a radial direction. Additionally, in some of these various embodiments, the chamber 106 extends at least partially throughout (e.g., partially throughout, substantially throughout, entirely throughout) the longitudinal length of the heat-transfer device 100.

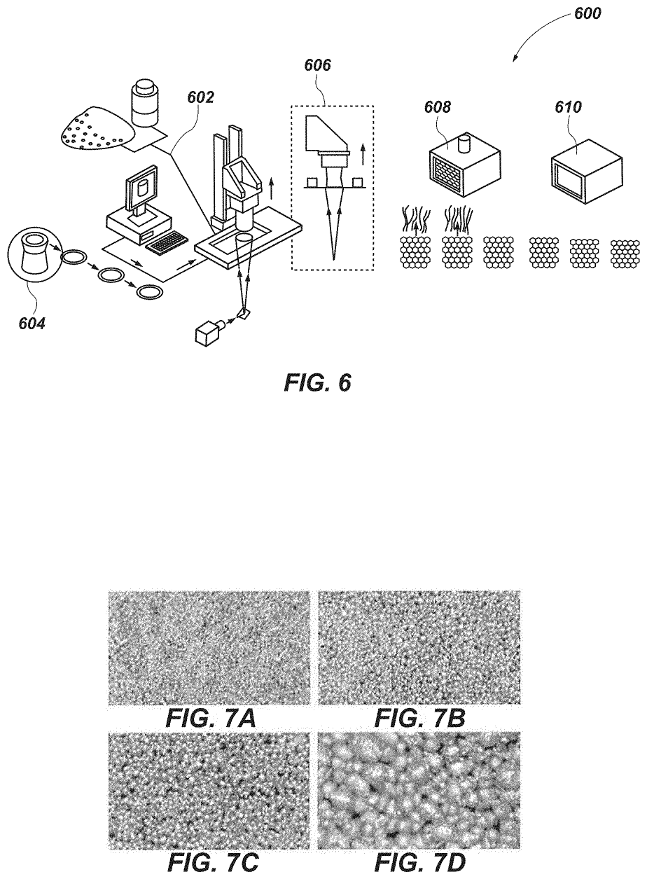

The heat-transfer device 100, including the tubular structure 110 and the exterior sheath 140, may be at least partially (e.g., partially, substantially, entirely) formed utilizing additive manufacturing techniques, as is described in greater detail below with reference to FIGS. 6-9. Additionally, in some embodiments, the heat-transfer device 100, including the tubular structure 110 and the exterior sheath 140, may be at least partially formed using conventional manufacturing techniques (e.g., die-casting techniques and/or material removal techniques such as subtractive manufacturing techniques). In some embodiments, the exterior sheath 140 is formed by conventional manufacturing techniques and the tubular structure 110 is formed by DLP. Forming the heat-transfer device 100, the tubular structure 110, and/or the exterior sheath 140 using DLP along with other additive manufacturing techniques may facilitate forming one or more components or portions of the heat-transfer device 100 to exhibit desired dimensions and geometries, and/or material properties (void fraction/porosity, pore size, median particle size, density, surface roughness, mechanical strength). In various embodiments, the tubular structure 110 is formed with a varying porosity/void fraction using DLP. In some embodiments, the tubular structure 110 includes at least two sections with different porosities.

The heat-transfer device 100 may be formed of and include one or more thermally conductive materials (e.g., a material or a material composition). As non-limiting examples, the heat-transfer device 100 may include one or more metals (e.g., copper (Cu), aluminum (Al), titanium (Ti), tungsten (W), nickel (Ni), niobium (Nb)), alloys (e.g., steel, stainless steel, copper-nickel, nickel-copper-iron-manganese-carbon-silicon, nickel-chromium-iron-molybdenum, cobalt-chromium-molybdenum, titanium-zirconium-molybdenum), ceramics (e.g., alumina (Al₂O₃), zirconia (ZrO₂), silica (SiO₂), hydroxyapatite (Ca₁₀(PO₄)₆(OH)₂), aluminum titanate (Al₂TiO₅), aluminum nitride (AlN), silicon carbide (SiC), silicon nitride (Si₃N₄)), piezo ceramics (e.g., lead zirconate titanate (PZT)), and/or ceramic metal composites, also referred to as “cermets,” (e.g., titanium carbide (TiC), titanium nitride (TiN), titanium carbonitride (TiCN), nickel chromium (NiCr)). In some embodiments, each of the tubular structure 110 and the exterior sheath 140 independently comprise one or more metals (e.g., copper, aluminum, titanium, tungsten, nickel, niobium), alloys (e.g., steel, stainless steel, copper-nickel, nickel-copper-iron-manganese-carbon-silicon, nickel-chromium-iron-molybdenum, cobalt-chromium-molybdenum, titanium-zirconium-molybdenum), ceramics (e.g., alumina (Al₂O₃), zirconia (ZrO₂), silica (SiO₂), hydroxyapatite (Ca₁₀(PO₄)₆(OH)₂), aluminum titanate (Al₂TiO₅), aluminum nitride (AlN), silicon carbide (SiC), silicon nitride (Si₃N₄)), piezo ceramics (e.g., lead zirconate titanate (PZT)), and/or ceramic metal composites, also referred to as “cermets,” (e.g., titanium carbide (TiC), titanium nitride (TiN), titanium carbonitride (TiCN), nickel chromium (NiCr)).

The heat-transfer device 100 may be formed of and include a material that is compatible with the working fluid 160 and may be selected based on the working fluid 160. Selecting the material(s) of the heat-transfer device 100 based on the working fluid 160 may improve the performance and operation of the heat-transfer device 100, such as, for example, by reducing corrosion. In some embodiments, the heat-transfer device 100 comprises a copper material and the working fluid 160 comprises water. In other embodiments, the heat-transfer device 100 comprises an aluminum material and the working fluid 160 comprises ammonia. In yet other embodiments, the heat-transfer device 100 comprises a tungsten material and the working fluid 160 comprises lithium. In some embodiments, the heat-transfer device 100 comprises a stainless steel material and the working fluid 160 comprises sodium.

FIG. 2 is a simplified partial perspective view of a heat-transfer device 200, in accordance with embodiments of the disclosure. In FIG. 2 and the associated description, functionally similar features (e.g., structures, materials) as those described above with reference to FIG. 1 are referred to with similar reference numerals incremented by 100. To avoid repetition, not all features shown in FIG. 2 are described in detail herein. Rather, unless described otherwise below, a feature in FIG. 2 designated by a reference numeral that is a 100 increment of the reference numeral of a previously described feature will be understood to be substantially similar to the previously described feature.

Referring now to FIG. 2, the heat-transfer device 200 may include a tubular structure 210 and an exterior sheath 240 encompassing (e.g., substantially surrounding) the tubular structure 210. The heat-transfer device 200 may include a first end 202 and a second end 204 opposite the first end 202. In various embodiments, the heat-transfer device 200 includes a chamber 206 defined by an interior wall 214 of the tubular structure 210.

In some embodiments, the tubular structure 210 includes a shape substantially the same as the shape of the exterior sheath 240. In some embodiments, an interior surface 242 of the exterior sheath 240 defines an inner diameter of the exterior sheath 240, and an exterior wall 212 of the tubular structure 210 defines an outer diameter of the tubular structure 210. In some embodiments, the outer diameter of the tubular structure 210 fits within the inner diameter of the exterior sheath 240. The exterior wall 212 of the tubular structure 210 may be on (e.g., indirectly contacting, directly contacting) the interior surface 242 of the exterior sheath 240. In some embodiments, the exterior wall 212 of the tubular structure 210 substantially conformally contacts the interior surface 242 of the exterior sheath 240. Physical contact between the tubular structure 210 and the exterior sheath 240 may improve the heat transfer between the surrounding environment and the heat-transfer device 200. In other embodiments, the exterior wall 212 of the tubular structure 210 is spaced from the interior surface 242 of the exterior sheath 240 to maintain an annular gap between the exterior wall 212 of the tubular structure 210 and the interior surface 242 of the exterior sheath 240.

The heat-transfer device 200 may include any desired material(s). In some embodiments, the heat-transfer device 200 comprises one or more homogeneous materials. In additional embodiments, the heat-transfer device 200 comprises one or more heterogeneous materials. As used herein, the term “homogeneous” in reference to a material means that the material composition, dimensions, and/or properties of the material do not vary in one or more directions (e.g., the axial direction, the radial direction) throughout different portions of the material. Conversely, as used herein, the term “heterogeneous” in reference to a material means the material, dimensions, and/or properties of the material vary in one or more directions throughout different portions of the material. The material, dimensions, and/or properties may vary stepwise (e.g., change abruptly), or may vary continuously (e.g., linearly, parabolically) throughout different portions of the material. In some embodiments, the heat-transfer device 200 comprises a functionally graded material (e.g., a material exhibiting properties changing in one or more dimensions).

In some embodiments, the heat-transfer device 200 includes a generally tubular shape, as described above with reference to the heat-transfer device 100. By way of non-limiting example, in various embodiments, the heat-transfer device 200 includes or more of a hollow cylinder, hollow ellipse, hollow square, hollow rectangle, or hollow triangle shape, and includes a central axis 207 (also referred to as a longitudinal axis) extending along a length of the heat-transfer device 200 from the first end 202 to the second end 204. The central axis 207 may extend along the geometric center of cross-sections of the chamber 206. In some embodiments, the heat transfer device 200 includes a larger dimension in the axial direction (e.g., along the central axis 207) than in a radial direction.

In some embodiments, the exterior sheath 240 exhibits one or more of the shapes described above with reference to the heat-transfer device 200. The exterior sheath 240 may be disposed around the central axis 207 of the heat-transfer device 200. In some embodiments, the exterior sheath 240, the tubular structure 210, and the chamber 206 are substantially concentrically disposed around the central axis 207. Additionally, the chamber 206 may extend at least partially throughout (e.g., partially throughout, substantially throughout, entirely throughout) the length of the heat-transfer device 200.

The exterior sheath 240 may form a fluid tight (e.g., hermetic) seal around the tubular structure 210 to contain a working fluid (e.g., the working fluid 160 (FIG. 1)) within the heat-transfer device 200 during use and operation of the heat-transfer device 200. Accordingly, in some embodiments, an exterior surface 244 of the exterior sheath 240 is substantially solid (e.g., non-porous, without limitation) and impermeable (e.g., a porosity impermeable to the working fluid and to fluids external to the heat-transfer device 200, without limitation) to fluids (e.g., the working fluid). Furthermore, in various embodiments, the entire exterior sheath 240 is substantially solid and impermeable to the working fluid and to fluids external to the heat-transfer device 200, which may facilitate heat transfer to and from the heat-transfer device 200 through the exterior sheath 240.

The exterior sheath 240 may be made of and include one or more thermally conductive materials to facilitate heat transfer between the working fluid and the external environment. The exterior sheath 240 may also include one or more of the materials described above with reference to the exterior sheath 140 (FIG. 1), such as, for example, one or more metals (e.g., copper, aluminum, titanium, tungsten, nickel, niobium), alloys (e.g., steel, stainless steel, copper-nickel, nickel-copper-iron-manganese-carbon-silicon, nickel-chromium-iron-molybdenum, cobalt-chromium-molybdenum, titanium-zirconium-molybdenum), ceramics (e.g., alumina (Al₂O₃), zirconia (ZrO₂), silica (SiO₂), hydroxyapatite (Ca₁₀(PO₄)₆(OH)₂), aluminum titanate (Al₂TiO₅), aluminum nitride (AlN), silicon carbide (SiC), silicon nitride (Si₃N₄)), piezo ceramics (e.g., lead zirconate titanate (PZT)), and/or ceramic metal composites, also referred to as “cermets,” (e.g., titanium carbide (TiC), titanium nitride (TiN), titanium carbonitride (TiCN), nickel chromium (NiCr)).

The interior wall 214 of the tubular structure 210 defines a central cavity 216 of the tubular structure 210. The central cavity 216 may extend from a first end 218 of the tubular structure 210 to a second end 220 of the tubular structure 210. In some embodiments, the tubular structure 210 is enclosed at the first end 218 and the second end 220, as described and illustrated above with reference to the tubular structure 110 of FIG. 1. In various embodiments, the tubular structure 210 includes channels 222 within the tubular structure 210 extending substantially parallel with the central axis 207. In some embodiments, the channels 222 extend from the first end 218 of the tubular structure 210 to the second end 220 of the tubular structure 210. The channels 222 are configured to provide a fluid pathway for the working fluid 160 (FIG. 1) in the liquid phase to return to the hot end after condensing at the cold end of the heat-transfer device 200.

In various embodiments, a thickness of the tubular structure 210 (e.g., in the radial direction) measured from the interior wall 214 to the exterior wall 212 of the tubular structure 210 is substantially constant (e.g., uniform) along the longitudinal length of the tubular structure 210 (e.g., in the direction of the central axis 207). In other embodiments, the tubular structure 210 includes a non-uniform radial thickness along the longitudinal length thereof. By way of non-limiting example, in various embodiments, the exterior wall 212 includes substantially uniform dimensions (e.g., a substantially constant outer diameter), and the dimensions of the interior wall 214 vary along the longitudinal length (e.g., in the axial direction along the central axis 207) of the tubular structure 210.

In some embodiments, portions of the tubular structure 210 proximate the first end 218 and the second end 220 include a different (e.g., larger, smaller) thickness than an interior portion of the tubular structure 210 positioned axially between the first end 218 and the second end 220. In some embodiments, the thickness of the tubular structure 210 at the first end 218 and the second end 220 is less than the thickness of the tubular structure 210 at the interior portion between the first end 218 and the second end 220. In some embodiments, the dimensions of the tubular structure 210 vary (e.g., continuously, abruptly) along an entire length of the tubular structure 210. In other embodiments, interior portions of the tubular structure 210 between the first end 218 and the second end 220 include a substantially uniform thickness, and the thickness of the tubular structure 210 proximate the first end 218 and the second end 220 varies (e.g., continuously, abruptly) from a relatively greater thickness proximate a midpoint of the interior portion to a relatively lesser thickness at each end of the interior portion proximate the first end 218 and the second end 220.

In some embodiments, a cross-sectional shape of the tubular structure 210 (e.g., along the central axis 207 in the Y-Z plane) includes a consistent, uniform structure along the length of the tubular structure 210. For example, a first cross-section of the tubular structure 210 in the Y-Z plane, taken at a first distance from the first end 218, may exhibit a first shape. Additionally, a second cross-section of the tubular structure 210 in the Y-Z plane, taken at a second distance (e.g., different than the first distance) from the first end 218, may exhibit a second shape. The first cross-sectional shape of the tubular structure 210 may be different than the second cross-sectional shape of the tubular structure 210. In additional embodiments, portions of a cross-section of the tubular structure 210 (e.g., in the Y-Z plane), at a certain distance from the first end 218, include a different thicknesses (e.g., in the radial direction) along the perimeter of the cross-section of the tubular structure 210. As a non-limiting example, in various embodiments, a cross-section of the tubular structure 210 at a certain distance from the first end 218 includes a first portion including a first thickness and a second portion including a second thickness. In some embodiments, the first thickness of the first portion is the same as the second thickness of the second portion. In additional embodiments, the first thickness of the first portion is different (e.g., greater than, less than) than the second thickness of the second portion.

Although FIG. 2 illustrates a particular number of channels 222, the number of channels 222 within the tubular structure 210 may be different than that illustrated. For example, in some embodiments, the tubular structure 210 includes fewer than eight channels 222, such as six channels 222, four channels 222, two channels 222, or a single channel 222. In other embodiments, the tubular structure 210 includes greater than eight channels 222, such as greater than ten channels 222, or greater than 12 channels 222.

In some embodiments, the channels 222 are disposed along the circumference of the tubular structure 210 at equal intervals. For example, the channels 222 may be disposed at different angular locations along the circumference of the tubular structure 210 and may be spaced from one another by from about 20° to about 180°, such as from about 20° to about 30°, from about 30° to about 45°, from about 45° to about 60°, from about 60° to about 90°, or from about 90° to about 180°.

A cross-sectional shape of the channels 222 may be one or more of circular, elliptical, square, rectangular, parallelogram, trapezium, rhombus, pentagonal, hexagonal, octagonal, and combinations thereof. In some embodiments, at least one of the channels 222 includes a first cross-sectional shape and other channels 222 include a second, different cross-sectional shape.

A size (e.g., a diameter) of the channels 222 may be selected based, at least partially, on the working fluid 160 and/or may be selected based on the overall size of the tubular structure 210. By way of non-limiting example, the diameter of the channels 222 may be within a range of from about 0.5 mm to about 10 mm, such as from about 0.5 mm to about 1.0 mm, from about 1.0 mm to about 3.0 mm, from about 3.0 mm to about 5.0 mm, or from about 5.0 mm to about 10.0 mm. In some embodiments, the channels 222 have a diameter of from about 1 mm to about 1.5 mm, such as about 1.25 mm.

In some embodiments, one or more portions of the heat-transfer device 200 are formed by additive manufacturing techniques including at least a DLP technique. Forming the tubular structure 210 by additive manufacturing, and in particular, DLP, may facilitate formation of one or more properties of the tubular structure 210 otherwise not achievable using conventional manufacturing techniques. By way of non-limiting example, forming the tubular structure 210, or at least a portion of the tubular structure 210, by the process disclosed herein using DLP may facilitate forming the tubular structure 210 to include the channels 222 having a desired diameter (e.g., less than about 5.0 mm, such as less than about 3.0 mm, or less than about 1.0 mm) and a desired geometry, and to form the tubular structure 210 to include one or more of a desired pore size, a desired void fraction/porosity, pore size, a desired median particle size, a desired surface roughness, and a desired mechanical strength. In some embodiments, the process disclosed herein using DLP to form the tubular structure 210 facilitates forming portions of tubular structure 210 in selected locations to include different properties (e.g., void fraction, pore size, median particle size, density, surface roughness, mechanical strength) than other portions of the tubular structure 210. By way of non-limiting example, the one or more properties are formed to vary in one or more directions.

The tubular structure 210 may exhibit a void fraction (the volume of voids divided by the total volume) within a range of from about 0.05 to about 1.0 (e.g., a porosity within a range of from about 5% to about 100%), such as from about 0.05 to about 0.10, from about 0.10 to about 0.20, from about 0.20 to about 0.40, from about 0.40 to about 0.60, from about 0.60 to about 0.80, from about 0.80 to about 0.90, or from about 0.90 to about 1.0.

A density of the tubular structure 210 may be depend, at least in part, on the material composition of the tubular structure 210 and the void fraction of the tubular structure 210. In some embodiments, the density of the tubular structure 210 is within a range of from about 0.1 g/cm³ to about 30 g/cm³, such as from about 1.0 g/cm³ to about 15.0 g/cm³, from about 1.0 g/cm³ to about 10.0 g/cm³, from about 3.0 g/cm³ to about 7.0 g/cm³, from about 10.0 g/cm³ to about 20.0 g/cm³, or from about 20.0 g/cm³ to about 30.0 g/cm³.

The pore size of the tubular structure 210 may be within a range of from about 1 nm to about 1 mm (1000 nm), such as from about 100 nm to about 200 μm, from about 100 nm to about 1 μm, from about 1 μm to about 5 μm, from about 5 μm to about 10 μm, from about 10 μm to about 20 μm, from about 20 μm to about 40 μm, from about 40 μm to about 60 μm, from about 60 μm to about 80 μm, from about 80 μm to about 100 μm, from about 100 μm to about 150 μm, or from about 150 μm to about 200 μm.

A median particle size of the tubular structure 210 may be within a range of from about 1 nm to about 1 mm (1000 nm), such as from about 100 nm to about 200 μm, from about 100 nm to about 1 μm, from about 1 μm to about 5 μm, from about 5 μm to about 10 μm, from about 10 μm to about 20 μm, from about 20 μm to about 40 μm, from about 40 μm to about 60 μm, from about 60 μm to about 80 μm, from about 80 μm to about 100 μm, from about 100 μm to about 150 μm, or from about 150 μm to about 200 μm. In some embodiments, the median particle size of the tubular structure 210 is larger than the pore size of the tubular structure 210. In other embodiments, the median particle size of the tubular structure 210 is less than the pore size of the tubular structure 210.

In some embodiments, the particle size of the tubular structure 210 is monomodal. In other embodiments, the tubular structure 210 includes a multimodal (e.g., bimodal, trimodal, quadmodal) distribution of particle sizes. In various embodiments, the multimodal particle size distribution includes mixtures with two or more median particle sizes. In various embodiments, the tubular structure 210 includes a particle mixture including a first median particle size, a second median particle size, a third median particle size, and/or a fourth median particle size. In various embodiments, the median particle sizes are within a range of from about 1 μm to about 200 μm, from about 1 μm to about 5 μm, from about 5 μm to about 10 μm, from about 10 μm to about 20 μm, from about 20 μm to about 40 μm, from about 40 μm to about 60 μm, from about 60 μm to about 80 μm, from about 80 μm to about 100 μm, from about 100 μm to about 150 μm, or from about 150 μm to about 200 μm. In some embodiments, the tubular structure 210 comprises a first median particle size within a range of from about 1 μm to about 10 μm, a second median particle size within a range of from about 15 μm to about 45 μm, a third median particle size within a range of from about 32 μm to about 45 μm, and a fourth median particle size within a range of from about 75 μm to about 150 μm.

In some embodiments, the void fraction of the tubular structure 210 is substantially uniform (e.g., homogeneous) throughout the tubular structure 210. In some such embodiments, the tubular structure 210 includes a substantially uniform void fraction in at least one direction. By way of non-limiting example, in some embodiments, the tubular structure 210 includes a substantially uniform void fraction in one or both of the axial direction and the radial direction. In other embodiments, the tubular structure 210 includes a substantially uniform void fraction in one direction (e.g., one of the axial direction and the radial direction) and a non-uniform (e.g., heterogeneous) void fraction in another direction (e.g., the other of the axial direction and the radial direction).

In other embodiments, the void fraction of the tubular structure 210 is non-uniform. In some embodiments, the tubular structure 210 includes a non-uniform void fraction in two directions (e.g., in the axial direction, and the radial direction).

In some embodiments, a portion of the tubular structure 210 includes a different (e.g., higher, or lower) property (e.g., void fraction, pore size, median particle size, density, surface roughness, mechanical strength) than another portion (e.g., additional portions, a remaining portion) of the tubular structure 210. For example, portions of the tubular structure 210 proximate the first end 218 and the second end 220 may exhibit a different (e.g., higher or lower) void fraction, pore size, median particle size, density, surface roughness, mechanical strength, and/or than interior portions of the tubular structure 210 between the first end 218 and the second end 220.

In some embodiments, portions of the tubular structure 210 proximate the first end 218 and the second end 220 include a higher void fraction than interior portions of the tubular structure 210 between the first end 218 and the second end 220. In some embodiments, forming the portions of the tubular structure 210 proximate the first end 218 and the second end 220 to include a higher void fraction than other portions of the tubular structure 210 may facilitate absorption and evaporation of the working fluid 160 (FIG. 1) proximate the first end 218 and the second end 220 during use and operation of the heat-transfer device 200.

Additionally, portions of the tubular structure 210 proximate the first end 218 and the second end 220 may exhibit a variable void fraction in the radial direction. By way of non-limiting example, in various embodiments, the tubular structure 210 includes a greater void fraction proximate the interior wall 214 and a lower void fraction proximate the channels 222 at the first end 218 and the second end 220. In one or more embodiments, the void fraction of the tubular structure 210 at the first end 218 and the second end 220 is functionally graded in the radial direction from the interior wall 214 towards the channels 222.

In some embodiments, the density of the tubular structure 210 is substantially uniform. In other embodiments, the density of the interior portion between the first end 218 and the second end 220 is greater than the density of the tubular structure 210 proximate (e.g., at) the first end 218 and the second end 220. In some embodiments, the density of the tubular structure 210 varies substantially consistently along the length thereof from a greatest density at a midpoint of the interior portion between the first end 218 and the second end 220 to a smallest density at the first end 218 and the second end 220. In some embodiments, the density of the tubular structure 210 varies with a radial distance from the central axis 207. In some embodiments, the density of the tubular structure 210 decreases with an increasing radial distance from the channels 222, such that portions of the tubular structure 210 proximate the channels 222 include a larger density than portions radially distal from the channels 222.

FIG. 3A illustrates a partial cutaway perspective view of a heat-transfer device 300 in accordance with embodiments of this disclosure. In FIG. 3A and the associated description, functionally similar features (e.g., structures, materials) as those previously described above with reference to FIG. 1 are referred to with similar reference numerals incremented by 200. To avoid repetition, not all features shown in FIG. 3A are described in detail herein. Rather, unless described otherwise below, a feature in FIG. 3A designated by a reference numeral that is a 200 increment of the reference numeral of a previously described feature will be understood to be substantially similar to the previously described feature.

Referring now to FIG. 3A, in various embodiments, the heat-transfer device 300 includes a tubular structure 310 including a first end 318 and a second end 320 opposite the first end 318. In some embodiments, the tubular structure 310 replaces the tubular structure 210 of the heat-transfer device 200 or the tubular structure 110 of the heat-transfer device 100. The tubular structure 310 may be formed by additive manufacturing techniques, and in particular, at least partially formed by a DLP technique, as will be described herein. The tubular structure 310 includes an exterior wall 312 and an interior wall 314 defining a central cavity 316 of the tubular structure 310. The tubular structure 310 also includes channels 322 between the exterior wall 312 and the interior wall 314. In various embodiments, the channels 322 extend from the first end 318 of the tubular structure 310 to the second end 320 of the tubular structure 310. In some embodiments, the tubular structure 310 is substantially similar to the tubular structure 210 (FIG. 2), except that the orientation of the channels 322 of the tubular structure 310 may be different than the orientation of the channels 222 (FIG. 2) of the tubular structure 210.

The tubular structure 310 may exhibit one or more of the shapes described above with reference to the tubular structure 210 (FIG. 2). In some embodiments, the tubular structure 310 includes a hollow cylindrical shape, such as a hollow right circular cylinder. As illustrated in FIG. 3A, the tubular structure 310 includes a central axis 317 (a longitudinal axis) extending from the first end 318 to the second end 320 along which the central cavity 316 extends. In various embodiments, when used with the heat-transfer device 100 of FIG. 1 or the heat-transfer device 200 of FIG. 2, the central axis 317 of the tubular structure 310 is substantially aligned with the central axis 107 of the heat-transfer device 100 (FIG. 1) or the central axis 207 of the heat-transfer device 200 (FIG. 2).

The materials of the tubular structure 310 may be formed of and include one or more of the materials described above with reference to the tubular structure 110 (FIG. 1), such as one or more metals (e.g., copper, aluminum, titanium, tungsten, nickel, niobium), alloys (e.g., steel, stainless steel, copper-nickel, nickel-copper-iron-manganese-carbon-silicon, nickel-chromium-iron-molybdenum, cobalt-chromium-molybdenum, titanium-zirconium-molybdenum), ceramics (e.g., alumina (Al₂O₃), zirconia (ZrO₂), silica (SiO₂), hydroxyapatite (Ca₁₀(PO₄)₆(OH)₂), aluminum titanate (Al₂TiO₅), aluminum nitride (AlN), silicon carbide (SiC), silicon nitride (Si₃N₄)), piezo ceramics (e.g., lead zirconate titanate (PZT)), and/or ceramic metal composites, also referred to as “cermets,” (e.g., titanium carbide (TiC), titanium nitride (TiN), titanium carbonitride (TiCN), nickel chromium (NiCr)).

The tubular structure 310 may be sized, shaped, and configured to optimize heat-transfer. In some embodiments, one or more of the dimensions, the geometry, and one or more properties (e.g., void fraction, pore size, median particle size, density, surface roughness, mechanical strength) may be tailored in one or more directions to facilitate desired properties of the tubular structure 310, as described above with reference to the tubular structure 210 (FIG. 2). In some embodiments, each of the void fraction, pore size, median particle size, and density is similar to that described above with reference to the respective void fraction, pore size, median particle size, and density of the tubular structure 210.

The tubular structure 310 may exhibit a uniform thickness (e.g., in the radial direction) measured from the interior wall 314 to the exterior wall 312 of the tubular structure 310. In other embodiments, the tubular structure 310 includes a non-uniform thickness. By way of non-limiting example, in various embodiments, the exterior wall 312 includes substantially uniform dimensions (e.g., a substantially constant outer diameter), and the dimensions of the interior wall 314 vary along the longitudinal length (e.g., in the axial direction along the longitudinal axis 317) of the tubular structure 310.

In some embodiments, end portions 324 of the tubular structure 310 that are proximate the first end 318 and the second end 320 include a different (e.g., larger, smaller) thickness than an interior portion 326 of the tubular structure 310 positioned axially between the end portions 324. In some embodiments, the thickness of the end portions 324 is less than the thickness of the interior portion 326. In some embodiments, the dimensions of the tubular structure 310 vary (e.g., continuously, abruptly) along an entire length of the tubular structure 310. In other embodiments, the interior portion 326 of the tubular structure includes a substantially uniform thickness, and the thickness of the end portions 324 varies (e.g., continuously, abruptly) from a relatively greater thickness proximate the interior portion 326 to a relatively lesser thickness distal to the interior portion 326.

In some embodiments, the void fraction of the tubular structure 310 is substantially similar to the void fraction of the tubular structure 310 described above with reference to the tubular structure 210. In some embodiments, the void fraction of the tubular structure 310 is substantially uniform. In other embodiments, the void fraction of the tubular structure 310 varies in at least one direction, as described above with reference to the void fraction of the tubular structure 210.

FIG. 3B illustrates a wire-frame view of the tubular structure 310 highlighting the internal geometry of the heat-transfer device 300 of FIG. 3A. Referring now to FIG. 3B, the tubular structure 310 may include channels 322 configured to act as a conduit for the working fluid 160 (FIG. 1) when the working fluid 160 (FIG. 1) is in the liquid phase. In various embodiments, the channels 322 extend at least partially throughout (e.g., partially throughout, substantially throughout, throughout) the tubular structure 310. For example, in some of these embodiments, the channels 322 extend from the first end 318 of the tubular structure 310 to the second end 320 of the tubular structure 310 along the central axis 317 (FIG. 3A) and between the exterior wall 312 and the interior wall 314. The tubular structure 310 may also include any number of (e.g., one or more) channels 322, as described above with reference to the channels 322. In some embodiments, the channels 322 are fluidly isolated from one another. In other embodiments, the channels 322 merge into one another, meaning that at least one channel 322 is in fluid communication with at least another channel 322 between the exterior wall 312 and the interior wall 314. The number of the channels 322 and the angular spacing between neighboring channels 322 may be the same as described above with reference to the channels 222.

The cross-sectional shape of the channels 322 may be substantially the same as the cross-sectional shape of the channels 222 described above. In various embodiments, as illustrated in FIG. 3B, the channels 322 include a helical and tortuous path. In other embodiments, the channels 322 include other tortuous paths. Helical and/or tortuous channels include a greater length and/or a greater surface area that contacts a working fluid (e.g., the working fluid 160 of FIG. 1), when compared to linear channels. Additionally, helical and/or tortuous channels may result in directional changes of the working fluid (e.g., the working fluid 160 of FIG. 1) within the channels 322, which may result in radial and axial mixing (e.g., bi-directional mixing) of the working fluid. For example, gravity may facilitate mixing in helical and/or tortuous channels by helping to distribute working fluid in the wick. The mixing of the working fluid in the radial direction and the axial direction may improve the effectiveness of heat-transfer compared to linear (e.g., axial) channels.

In some embodiments, the channels 322 are configured for a higher amount of heat transfer proximate (e.g., at) the end portions 324 of the tubular structure 310 than at the interior portion 326. For example, in various embodiments, the channels 322 include a greater number of helices and/or tortuosity proximate the end portions 324 of the tubular structure 310 (e.g., the helices include a smaller pitch adjacent to the end portions 324 than at the interior portion 326). In some embodiments, the channels 322 (e.g., each of the channels 322) include a 360° revolution proximate the end portions 324 of the tubular structure 310 and are substantially straight (e.g., linear and extending substantially parallel with the central axis 317 (FIG. 3A)) along the interior portion 326. In various embodiments, the channels 322 include generally helical geometries. However, in some of these embodiments, the channels 322 also include minor tortuous (e.g., serpentine, without limitation) geometries along the helices. In various embodiments, the minor tortuous geometries of the channels 322 include corrugations and/or coils along at least part (e.g., a part, a substantial part, the entirety) of the length of the channels 322. In some embodiments, the channels 322 include a non-uniform diameter. In some embodiments, one or more channels 322 include a different geometry from at least one other channel 322. For example, in some embodiments, at least one of the channels 322 is substantially linear and at least one other of the channels 322 include a tortuous (e.g., serpentine) path.

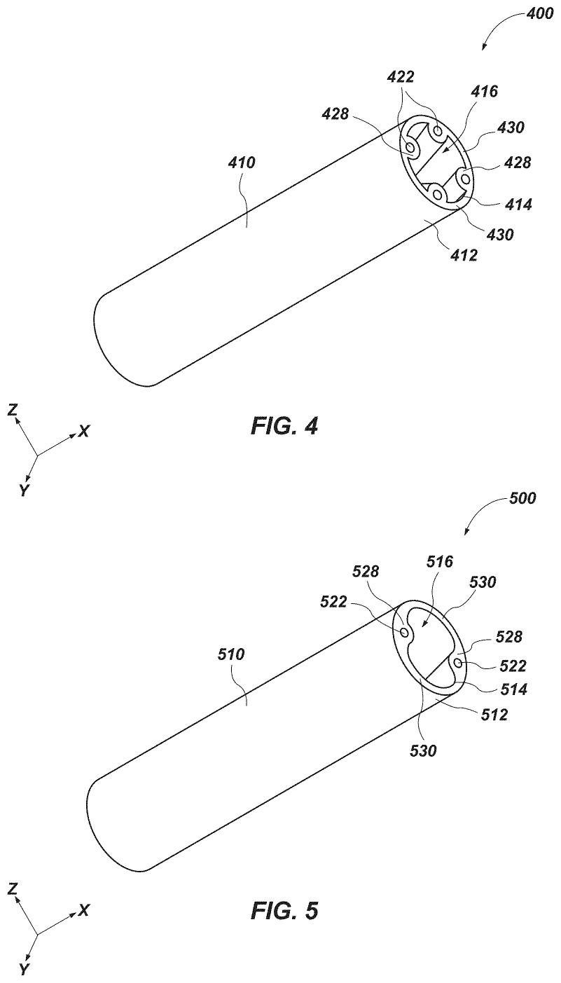

FIG. 4 is a simplified perspective view of a heat-transfer device 400, in accordance with embodiments of this disclosure. In FIG. 4 and the associated description, functionally similar features (e.g., structures, materials) to those of FIG. 3A and FIG. 3B are referred to with similar reference numerals incremented by 100. To avoid repetition, not all features shown in FIG. 4 are described in detail herein. Rather, unless described otherwise below, a feature in FIG. 4 designated by a reference numeral that is a 100 increment of the reference numeral of a feature previously described in FIG. 3A and FIG. 3B will be understood to be substantially similar to the previously described feature.

Referring now to FIG. 4, the heat-transfer device 400 may include a tubular structure 410. The tubular structure 410 includes an exterior wall 412 and an interior wall 414 defining a central cavity 416. In various embodiments, the tubular structure 410 includes channels 422 defined between the exterior wall 412 and the interior wall 414. In various embodiments, the tubular structure 410 includes a non-uniform thickness (e.g., in the radial direction) measured from the interior wall 414 to the exterior wall 412 of the tubular structure 410. For example, in some of these various embodiments, the tubular structure 410 includes thicker portions 428 protruding within the central cavity 416 with the channels 422 formed therein, and thinner portions 430 circumferentially between the thicker portions 428 of the tubular structure 410. As illustrated in FIG. 4, the tubular structure 410 includes four channels that may be uniformly or non-uniformly spaced from one another (e.g., equidistantly at 90° increments). In some embodiments, a transition region from thick portions of the tubular structure 410 to thin portions of the tubular structure 410 is abrupt, as shown in FIG. 4.

The tubular structure 410 may include properties (e.g., density, pore size, void fraction, pore size, median particle size, surface roughness, mechanical strength) substantially similar to those described above with reference to the tubular structure 210 (FIG. 2). In addition, the channels 422 may include substantially the same size and shape as the channels 222, 322 described above. In various embodiments, the thicker portions 428 and the channels 422 formed therein include a helical structure.

The tubular structure 410 may replace the tubular structure 110 of the heat-transfer device 100 or may replace the tubular structure 210 of the heat-transfer device 200.

FIG. 5 is a perspective view of a heat-transfer device 500, in accordance with embodiments of this disclosure. In FIG. 5 and the associated description, functionally similar features (e.g., structures, materials) to those of FIG. 3A and FIG. 3B are referred to with similar reference numerals incremented by 200. To avoid repetition, not all features shown in FIG. 5 are described in detail herein. Rather, unless described otherwise below, a feature in FIG. 5 designated by a reference numeral that is a 200 increment of the reference numeral of a feature previously described in FIG. 3A and FIG. 3B will be understood to be substantially similar to the previously described feature.

Referring now to FIG. 5, the heat-transfer device 500 may include a tubular structure 510. The tubular structure 510 includes an exterior wall 512 and an interior wall 514 defining a central cavity 516. In various embodiments, the tubular structure 510 includes channels 522 defined between the exterior wall and the interior wall 514. In various embodiments, the tubular structure 510 includes a non-uniform thickness (e.g., in the radial direction) measured from the interior wall 514 to the exterior wall 512 of the tubular structure 510. For example, in some of these various embodiments, the tubular structure 510 includes thicker portions 528 protruding within the central cavity 516 with the channels 522 formed therein, and thinner portions 530 circumferentially between the thicker portions 528. As illustrated in FIG. 5, the channels 522 of the thicker portions 528 are spaced opposite from one another (e.g., 180° apart) and are located closer to each other than opposing channels 522 of the thinner portions 530. In some embodiments, a transition region from thick portions of the tubular structure 510 to thin portions of the tubular structure 510 is gradual (e.g., continuous). For example, as shown in FIG. 5, the thicker portions 528 of the tubular structure 510 that include the channels 522 include filets or radiuses within the transition region to the thinner portions 530 of the tubular structure 510.

The tubular structure 510 may include properties (e.g., density, pore size, void fraction, pore size, median particle size, surface roughness, mechanical strength) substantially similar to those described above with reference to the tubular structure 210 (FIG. 2). In addition, the channels 522 may include substantially the same size and shape as the channels 222, 322 described above.

The tubular structure 510 may replace the tubular structure 110 of the heat-transfer device 100 or may replace the tubular structure 210 of the heat-transfer device 200.

FIG. 6 schematic illustrating stages representative of an additive manufacturing process 600 for forming devices (e.g., the heat-transfer device 100 (FIG. 1), the heat-transfer device 200 (FIG. 2), the heat-transfer device 300 (FIG. 3A, FIG. 3B), the heat-transfer device 400 (FIG. 4), and/or the heat-transfer device 500 (FIG. 5)) in accordance with embodiments of the disclosure. In various embodiments, the additive manufacturing processes are utilized to form the heat-transfer device with materials, dimensions, geometries, and/or material properties (surface roughness, density, void fraction, median particle size, mechanical strength) that are tailored to a specific application. Forming the heat-transfer device includes forming a tubular structure (e.g., the tubular structure 110 (FIG. 1), the tubular structure 210 (FIG. 2), the tubular structure 310 (FIG. 3A, FIG. 3B), the tubular structure 410 (FIG. 4), and/or the tubular structure 510 (FIG. 5)), and/or the exterior sheath (e.g., the exterior sheath 140 (FIG. 1), the exterior sheath 240 (FIG. 2)) utilizing additive manufacturing techniques. For example, additive manufacturing techniques may enable simultaneously forming the tubular structure and the exterior sheath.

Referring now to FIG. 6, in some embodiments, the additive manufacturing process 600 includes a DLP additive manufacturing process. In various embodiments, the process disclosed herein using DLP may provide certain advantages relative to other additive manufacturing processes. For example, in various embodiments, the process disclosed herein utilizing digital light processing may enable the formation of devices having dimensions, geometries, and porosities/void fractions that may not be achievable utilizing other additive manufacturing processes and/or conventional manufacturing techniques. Additionally, the process disclosed herein utilizing digital light processing may reduce the total additive manufacturing time to form a device and/or enable multiple devices to be formed simultaneously. Furthermore, the process disclosed herein utilizing digital light processing may facilitate the formation of devices having desired geometries without residual material (e.g., powder particles) becoming trapped within internal channels or passageways, such as within the channels 222 (FIG. 2), 322 (FIG. 3A, FIG. 3B), 422 (FIG. 4), 522 (FIG. 5) of the additively manufactured device.

In various embodiments, the additive manufacturing process 600 includes mixing a material powder and a photocurable resin to form a slurry, as illustrated in act 602. In some of these various embodiments, forming the slurry of the photocurable resin and the powder material includes forming several slurries, each including different powder material particle size mixtures.

The material powder may include particles having a size (e.g., diameter) ranging from about 1 nm to about 1 mm. In some embodiments, the material powder includes particles smaller than about 200 μm, smaller than about 150 μm, smaller than about 100 μm, smaller than about 50 μm, or smaller than about 20 μm. Additionally, in some embodiments, the powder material includes particles having a size within a range of from about 15 μm to about 45 μm, from about 32 μm to about 45 μm, or from about 75 μm to about 150 μm.

The material powder may exhibit a monomodal distribution of particle sizes. In other embodiments, the material powder includes a mixture of varying particle sizes and/or particle size ranges. For example, in various embodiments, the material powder includes a multimodal mixture (e.g., a multimodal mixture chosen from one of a bimodal mixture, a trimodal mixture, and a quadmodal mixture) with a distribution of distinct particle size ranges. In some of these embodiments, the material powder includes a mixture that includes a first particle size range, a second particle size range, a third particle size range, and/or a fourth particle size range. In some embodiments, the material powder mixture comprises a first particle size range of smaller than about 20 μm, a second particle size range of from about 15 μm to about 45 μm, a third particle size range of from about 32 μm to about 45 μm, and a fourth particle size range of from about 75 μm to about 150 μm. Additionally, in various embodiments, the material powder includes mixtures formed by gas atomization to evenly mix various particle sizes throughout the material powder.

The powder material may include any suitable material for a heat-transfer device (e.g., a thermally conductive material). In various embodiments, the powder material includes one or more of the materials described above with reference to the heat-transfer devices 100, 200, 300, 400, 500 including the exterior sheaths 140, 240 and the tubular structures 110, 210, 310, 410, 510. By way of non-limiting example, in various embodiments, the power material includes one or more metals (e.g., copper, aluminum, titanium, tungsten, nickel, niobium), alloys (e.g., steel, stainless steel, copper-nickel, nickel-copper-iron-manganese-carbon-silicon, nickel-chromium-iron-molybdenum, cobalt-chromium-molybdenum, titanium-zirconium-molybdenum), ceramics (e.g., alumina (Al₂O₃), zirconia (ZrO₂), silica (SiO₂), hydroxyapatite (Ca₁₀(PO₄)₆(OH)₂), aluminum titanate (Al₂TiO₅), aluminum nitride (AlN), silicon carbide (SiC), silicon nitride (Si₃N₄)), piezo ceramics (e.g., lead zirconate titanate (PZT)), and/or ceramic metal composites, also referred to as “cermets,” (e.g., titanium carbide (TiC), titanium nitride (TiN), titanium carbonitride (TiCN), nickel chromium (NiCr)).

The photocurable resin may react with UV light to induce a crosslinking reaction in the photocurable resin that polymerizes the material (e.g., a polymer) into a solid part. The photocurable resin may be a composition that includes, for example, one or more constituents. For example, in some embodiments, the photocurable resin includes a first constituent (e.g., the polymer) comprising, for example, methyl acrylate, urethane oligomer, cyanoacrylate, acrylate oligomer, and/or acrylic ester (e.g., aliphatic acrylate). As non-limiting examples, the first constituent may include a high molecular weight polyethylene oxide (e.g., ALKOX®), pentaerythritol tetraacrylate, 2-butylamino carbonyl oxy ethyl acrylate, di-trimethylopropane tetraacrylate. In various embodiments, the first constituent comprises a majority of the composition of the photocurable resin. For example, in some embodiments, the polymer comprises from about 90 wt % to about 99.9 wt % of the photocurable resin composition. In some embodiments, the photocurable resin additionally includes a second constituent (e.g., diphenylphosphine oxide, diphenyl (2,4,6-trimethylbenzoyl) phosphine oxide, riboflavin, bisacrylphosphrine, ivocerin, dibutylin dilaurate (DBTL), lithium chloride, and/or irgacure) that functions as a photoinitiator. In various embodiments, the second constituent (e.g., photoinitiator) comprises from about 0.1 wt % to about 10 wt % of the photocurable resin composition. In various embodiments, the photocurable resin also includes mixtures of materials, such as, for example, a mixture of polypropylene fumarate, diethyl fumarate, and bisacrylphosphine oxide. In some embodiments, the photocurable resin comprises from about 70 wt % to about 90 wt % aliphatic acrylate, from about 10 wt % to about 30 wt % acrylate oligomer, and from about 0.1 wt % to about 4 wt % diphenyl(2,4,6-trimethylbenzoyl)phosphine oxide.

In various embodiments, the photocurable resins also include one or more phase-addition materials (e.g., liquid phase sintering materials). In some of these various embodiments, the phase addition materials include 316L stainless steel combined with tungsten, which may improve consolidation and/or mechanical strength.

The additive manufacturing process 600 may include dividing (e.g., slicing) a three-dimensional (3D) computer-aided design (CAD) model of the device to be additively manufactured into layers, as shown in act 604. In various embodiments, a controller of the additive manufacturing system is configured to slice the 3D CAD model into layers and upload the layers of the slices of the 3D CAD model to the additive manufacturing tool. In various embodiments, the controller generates the 3D CAD model to include instructions for the additive manufacturing to form a green/pre-sintered device (e.g., the heat-transfer device of any of FIGS. 1-5 in a pre-sintered state) to include desired dimensions (in the pre-sintered state) and/or material properties (e.g., surface roughness, density, void fraction, pore size, median particle size, mechanical strength). Accordingly, the layers of the slices of the 3D CAD model include substantially similar dimensions and/or material properties (e.g., particle distribution) as the green device to be formed.

The additive manufacturing process 600 may include printing the green device based at least partially on the dimensions and/or the material properties of the 3D CAD model, as shown in act 606. For example, at each layer, the additive manufacturing machine, such as a DLP device, deposits one or more layers of material (e.g., the slurry) on a surface of a substrate at targeted locations based on the dimensions and/or the material properties (e.g., particle distribution) of the layers of the slices of the 3D CAD model representing the green device to be formed. In some embodiments, the process includes selectively depositing the several slurries to form the at least two sections of the green part with different particle distributions. The material is polymerized by exposing the slurry to ultraviolet (UV) light to cure (e.g., harden) the material. Sequential layers of material are placed at targeted locations and cured based on the dimensions and/or material properties of the sliced 3D CAD model layers until the at least a portion of the green device is formed. In some embodiments, sequential layers are covalently bonded to each other to form covalent bonds between neighboring layers.

In some embodiments, forming (e.g., printing) the device includes forming at least one green portion of the device with varying properties. For example, in various embodiments, the additive manufacturing process 600 utilizes a certain particle size mixture and/or material to form a first green section of the device or a component of the device including a first particle distribution, and after forming the first green section of the device (or the component of the device), forming a second green section of the device (or the component of the device) including a second particle distribution by loading a different particle size and/or particle size mixture into the additive manufacturing system. In various embodiments, other properties may also be varied, such as the thermal profile of each of the green sections of the component/device. In various embodiments, particle sizes, particle size mixtures, and/or additive manufacturing system settings may be varied to print a first green part of a device (e.g., the tubular structure of any of FIGS. 1-5) with varying properties and a second green part of the device (e.g., the exterior sheath of any of FIGS. 1-2). The separate green sections and/or green parts of the device may be subsequently combined (e.g., via sintering) to form a complete device.

In additional embodiments, forming (e.g., printing) the device may include sequentially using isolated slurries/mixtures of powder material and resin during the additive manufacturing process 600 to continuously form a substantially complete green device including the varying properties (e.g., particle distribution). For example, several slurries of material, each including different powder material particle size mixtures, are selectively used during the formation of a green part during the additive manufacturing process 600. In some embodiments, the additive manufacturing process 600 simultaneously form a green heat-transfer device to form a substantially non-porous exterior sheath (e.g., the exterior sheath 140 (FIG. 1), the exterior sheath 240 (FIG. 2)), and a tubular structure (e.g., the tubular structure 110 (FIG. 1), the tubular structure 210 (FIG. 2), the tubular structure 310 (FIG. 3A, FIG. 3B), the tubular structure 410 (FIG. 4), and/or the tubular structure 510 (FIG. 5)) including varying porosity (after sintering) throughout portions of the tubular structure. In various embodiments, tubular structures with varying porosity are formed by selectively distributing varying particle sizes during a DLP process. In various embodiments, sections of a green component/part with varying particle distributions are co-printed using resin strips with different densities.

After forming the green device, at least some of the resin may remain within the interstitial spaces of the green device. In some embodiments, the additive manufacturing process 600 includes performing a debinding process on the green device to remove the resin from the green device, as shown in act 608. The debinding process may drive out the resin remaining in the device and leave only the desired material (e.g., metal, ceramic, and/or cermet) remaining within the green device. In some embodiments, the debinding process includes exposing the green device to predetermined debinding conditions, such as a predetermined temperature to substantially remove the resin from the green structure. In some embodiments, the predetermined temperature is between about 300° C. and about 400° C., in other embodiments, the predetermined temperature is one of a temperature greater than about 250° C., greater than about 300° C., greater than about 350° C., greater than about 450° C., or greater than about 550° C. In various embodiments, the predetermined debinding conditions include at least one atmosphere chosen from a humidifying atmosphere and an oxidizing atmosphere. In some of these various embodiments, the predetermined temperature is maintained between about 300° C. and about 330° C. to control oxide formation on metals, such as 316L SS, during the debinding process (as illustrated in FIG. 9). The debinding process may occur in air or within an inert environment. In various embodiments, the process 600 includes passing fluid through channels formed in the green part to remove uncured resin that remain therein. In various embodiments, the removal of the resin during the debinding process results in a component with varying porosities due to the varying particle distributions of the slurries used during the formation of the green part.

In some embodiments, after performing the debinding process, the additive manufacturing process 600 includes sintering the remaining material (e.g., metal, ceramic, and/or cermet) to form a sintered structure, as shown in act 610. In various embodiments, the sintering process is performed in an inert environment to prevent contamination and/or oxidation. In some embodiments, the debinding process and the sintering process are performed in different environments. Sintering the green device may result in shrinkage (e.g., up to about 30%) and in various embodiments, also changes material properties (e.g., density, porosity) of the debinded structure. In some embodiments, the 3D CAD models include oversized dimensions and/or altered material properties (e.g., density, porosity) relative to the sintered device to be formed. For example, oversized 3D CAD models may be used to form oversized green parts that may include certain particle sizes and/or distributions of particle sizes of the material powder to account for the shrinkage that occurs due to the sintering process.

Although FIG. 6 illustrates stages of a DLP additive manufacturing process, the additive manufacturing process 600 is not so limited. In other embodiments, one of more acts of the additive manufacturing process 600 may include binder jet additive manufacturing, stereolithography, powder bed fusion (e.g., direct metal laser sintering, selective laser sintering, selective heat sintering, electron beam melting, direct metal laser melting), direct energy deposition, material extrusion, or sheet lamination (e.g., laminated object manufacturing, ultrasonic additive manufacturing). For example, in some embodiments, the tubular structure is formed using a DLP additive manufacturing process, such as the process 600 discussed above, and the exterior sheath is formed by a different additive manufacturing process, after which, the tubular structure and exterior sheath are then joined together, such as via sintering.

FIGS. 7A-7D includes optical microscopy images showing the microstructure of heat-transfer devices formed using the additive manufacturing process 600 of FIG. 6 under magnification. FIGS. 7A-7D each illustrate the microstructure of a device having a different particle size range after exposure to the same sintering time and temperature. For example, the microstructure illustrated in FIGS. 7A-7D may be of portions of the heat-transfer device after undergoing a sintering process at a constant temperature (e.g., at about 1200° C.). FIG. 7A illustrates the post-sintered microstructure of a portion of the device with particle sizes of less than about 20 μm. FIG. 7B illustrates the post-sintered microstructure of a portion of the device with particle sizes within a range of from about 15 μm to about 45 μm. FIG. 7C illustrates the post-sintered microstructure of a portion of the device with particle sizes within a range of from about 32 μm to about 45 μm. FIG. 7D illustrates the post-sintered microstructure of a portion of the device with particle sizes within a range of from about 75 μm to about 150 μm.

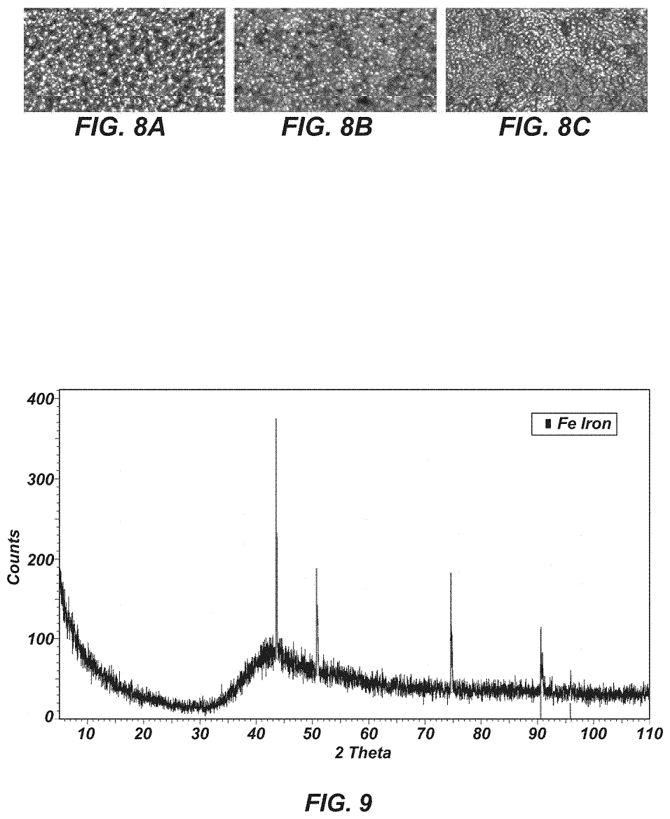

FIGS. 8A-8C includes optical microscopy images showing how the microstructure of heat-transfer devices formed using the additive manufacturing process 600 of FIG. 6 appear under magnification. In FIGS. 8A-8C, each image displays a consistent particle size range (e.g., from about 32 μm to about 45 μm) and illustrates the microstructure of the sintered device when exposed to different temperatures for the same duration of time. FIG. 8A illustrates the post-sintered microstructure of a portion of the device at a temperature of about 1200° C. FIG. 8B illustrates the post-sintered microstructure of a portion of the device at a temperature of about 1250° C. FIG. 8C illustrates the post-sintered microstructure of a portion of the device at a temperature of about 1300° C.

FIG. 9 illustrates x-ray diffraction spectra of heat-transfer devices formed from the additive manufacturing process 600, after sintering. The heat-transfer devices were formed using digital light processing and a powder material comprising 316L stainless steel. The x-ray diffraction spectra illustrate peaks for austenite (γ-Fe), indicating that the sintered structure includes iron without the presence of oxides such as (Cr₂O₃). Thus, the x-ray diffraction spectra demonstrates that the sintered heat-transfer devices are substantially free of oxidation.

Embodiments of heat-transfer devices in accordance with this disclosure may provide improved heat-transfer compared to conventional devices. Configurations of devices (e.g., heat-transfer devices) in accordance with embodiments of this disclosure may be tailored to a specific application to facilitate more efficient and effective heat transfer than conventional devices. For example, the materials, material thicknesses, and/or material properties (surface roughness, density, porosity, mechanical strength) of the devices herein may vary at certain portions of the devices. Additionally, the materials, material thicknesses, and/or material properties of the devices herein may vary directionally within portions of the device.

As used herein, the singular forms following “a,” “an,” and “the” are intended to include the plural forms as well, unless the context clearly indicates otherwise.

As used herein, “about” in reference to a numerical value for a particular parameter is inclusive of the numerical value and a degree of variance from the numerical value that one of ordinary skill in the art would understand is within acceptable tolerances for the particular parameter. For example, “about” in reference to a numerical value may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

As used herein, “and/or” includes any and all combinations of one or more of the associated listed items.

As used herein, the terms “comprising,” “including,” and grammatical equivalents thereof are inclusive or open-ended terms that do not exclude additional, un-recited elements or method steps.

As used herein, the term “configured” refers to a size, shape, material composition, and arrangement of one or more of at least one structure and at least one apparatus facilitating operation of one or more of the structure and the apparatus in a predetermined way.

As used herein, any relational term, such as “first,” “second,” etc., is used for clarity and convenience in understanding the disclosure and accompanying drawings, and does not connote or depend on any specific preference or order, except where the context clearly indicates otherwise.

As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded.

As used herein, reference to a feature being “on” an additional feature includes the features being in contact with one another, as well as directly or indirectly coupled to one another, connected to one another, attached to one another, or secured to one another.

As used herein, the term “substantially” in reference to a given parameter, property, or condition means and includes to a degree that one of ordinary skill in the art would understand that the given parameter, property, or condition is met with a degree of variance, such as within acceptable tolerances. By way of example, depending on the particular parameter, property, or condition that is substantially met, the parameter, property, or condition may be at least 90.0 percent met, at least 95.0 percent met, at least 99.0 percent met, at least 99.9 percent met, or even 100.0 percent met.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternative useful combinations of the elements described, will become apparent to those skilled in the art from the description. Such modifications and embodiments also fall within the scope of the appended claims and equivalents.

1. A method of additively manufacturing a heat-transfer device, the method comprising:
forming a first green structure using digital light processing, the first green structure including a different porosity in at least two sections;
exposing the first green structure to heat to remove resin used during the digital light processing from the first green structure; and
sintering the first green structure to form at least a portion of the heat-transfer device.

2. The method of claim 1, wherein sintering the first green structure comprises forming a wick and an exterior sheath of the heat-transfer device, the wick including the different porosity in the at least two sections.

3. The method of claim 2, further comprising forming a second green structure using an additive manufacturing process different than the digital light processing and sintering the second green structure to the first green structure, wherein sintering the second green structure forms the exterior sheath of the heat-transfer device.

4. The method of claim 1, wherein forming the first green structure includes co-printing the first green structure using resin strips with different densities.

5. The method of claim 1, wherein exposing the first green structure to heat comprises exposing the first green structure to a temperature between about 300° C. and about 400° C.

6. The method of claim 1, wherein forming the first green structure using digital light processing comprises forming the green structure from a slurry of a photocurable resin and a powder material including a metallic powder.

7. The method of claim 6, wherein exposing the first green structure to heat comprises exposing the first green structure to heat and at least one of a humidifying atmosphere and an oxidizing atmosphere.

8. The method of claim 7, wherein exposing the first green structure to heat comprises exposing the first green structure to a temperature between about 300° C. and about 330° C.

9. The method of claim 1, wherein forming the first green structure using the digital light processing comprises forming the first green structure including channels, and the method further includes passing fluid through the channels to remove uncured resin prior to sintering the first green structure.

10. The method of claim 1, wherein sintering the first green structure to form at least a portion of the heat-transfer device comprises forming a wick of the heat-transfer device, the wick including the at least two sections with different porosities, the wick comprising:
an exterior wall;
an interior wall defining a central cavity; and
at least one channel between the exterior wall and the interior wall.

11. A method of additively manufacturing a heat-transfer device, the method comprising:
forming a slurry of a photocurable resin and a powder material;
depositing one or more layers of the slurry on a surface of a substrate;
using digital light processing to form one or more layers of a first green structure with a first particle distribution;
forming additional layers on the one or more layers of the first green structure using the digital light processing to form the first green structure, the additional layers with a second particle distribution different than the first particle distribution;
exposing the first green structure to heat to remove the resin from the first green structure; and
sintering the first green structure to form the heat-transfer device, the heat-transfer device including at least two sections with different porosities.

12. The method of claim 11, further comprising forming a second green structure using an additive manufacturing process different than the digital light processing and sintering the second green structure to the first green structure to form an exterior sheath.

13. The method of claim 11, wherein a thermal profile of the first green structure is varied across sections of the first green structure.

14. The method of claim 11, wherein forming the slurry of the photocurable resin and the powder material comprises forming the powder material to include a multimodal mixture of particle sizes.

15. The method of claim 11, wherein forming the slurry of the photocurable resin and the powder material includes forming several slurries, each including different powder material particle size mixtures forming different particle distributions.

16. The method of claim 15, wherein depositing the one or more layers of the slurry on the surface of the substrate includes selectively depositing the several slurries to form the at least two sections with different particle distributions.

17. The method of claim 11, wherein the first green structure includes channels, and the method further includes passing fluid through the channels to remove uncured resin prior to sintering the first green structure.

18. A heat-transfer device, comprising:
a wick including at least two sections with different porosities, the wick comprising:
an exterior wall;
an interior wall defining a central cavity; and
at least one channel between the exterior wall and the interior wall.

19. The heat-transfer device of claim 18, wherein a porosity of ends of the wick is different than a porosity of an interior portion of the wick, the interior portion between the ends of the wick.

20. The heat-transfer device of claim 18, wherein a porosity of the wick is lower in portions of the wick adjacent to the at least one channel.
